(19) United States
(12) Patent Application Publication
(10) Pub. No.: US 2020/0302331 A1
(43) Pub. Date: Sep. 24, 2020

(54) INTELLIGENT PROBLEM SOLVING USING VISUAL INPUT

(71) Applicant: INTERNATIONAL BUSINESS MACHINES CORPORATION, Armonk, NY (US)

(72) Inventors: Vincent LONIJ, Dublin (IE); Debasis GANGULY, Dublin (IE); Beat BUESSER, Ashtown (IE); Ambrish RAWAT, Dublin (IE)

(73) Assignee: INTERNATIONAL BUSINESS MACHINES CORPORATION, Armonk, NY (US)

(21) Appl. No.: 16/358,799

(22) Filed: Mar. 20, 2019

(51) Int. Cl. G06N 20/00

(52) U.S. Cl. CPC G06N 20/00; G06K 9/00624

(57) ABSTRACT

Embodiments for intelligent problem solving using visual input by a processor. An interactive dialog may be initiated using the one or more IoT computing devices for receiving one or more instructions, objectives, and the contextual information to define a selected task. Visual data and contextual information associated with the visual data may be collected from one or more Internet of Things (“IoT”) computing devices. One or more solutions may be for a selected task using the visual data and contextual data.

### BACKGROUND OF THE INVENTION

### Field of the Invention

The present invention relates in general to computing systems, and more particularly to, various embodiments for intelligent problem solving using visual input to a user by a processor.

### Description of the Related Art

In today's society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure. IoT devices may be embedded in a variety of physical devices or products.

As great strides and advances in technologies come to fruition, these technological advances can be then brought to bear in everyday life. For example, the vast amount of available data made possible by computing and networking technologies may then assist in improvements to quality of life and appropriate living conditions.

### SUMMARY OF THE INVENTION

Various embodiments for intelligent problem solving using visual input using one or more processors, are provided. In one embodiment, by way of example only, a method for intelligent problem solving using visual input to accomplish a task, again by a processor, is provided. An interactive dialog may be initiated using the one or more IoT computing devices for receiving one or more instructions, objectives, and the contextual information to define a selected task. Visual data and contextual information associated with the visual data may be collected from one or more Internet of Things (“IoT”) computing devices. One or more solutions may be for a selected task using the visual data and contextual data.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is an additional block flow diagram depicting an exemplary operation for intelligent problem solving using visual input by a processor, again in which aspects of the present invention may be realized;

FIG. 5 is an additional block flow diagram depicting an exemplary operation for initiating goal classification by a processor, again in which aspects of the present invention may be realized;

FIG. 6 is an additional block flow diagram depicting an exemplary operation for instruction/query generation by a processor, again in which aspects of the present invention may be realized;

FIG. 7 is diagram depicting user modeling computing environment in which aspects of the present invention may be realized;

FIG. 8 is diagram depicting modeling of similar users computing environment in which aspects of the present invention may be realized; and

FIG. 9 is a flowchart diagram depicting an exemplary method for intelligent problem solving using visual input by a processor, again in which aspects of the present invention may be realized.

### DETAILED DESCRIPTION OF THE DRAWINGS

Computing systems may include large scale computing called “cloud computing,” in which resources may interact and/or be accessed via a communication system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Additionally, the Internet of Things (IoT) is an emerging concept of computing devices that may be embedded in objects, especially appliances, and connected through a network. An IoT network may include one or more IoT devices or “smart devices”, which are physical objects such as appliances with computing devices embedded therein. Many of these objects are devices that are independently operable, but they may also be paired with a control system or alternatively a distributed control system such as one running over a cloud computing environment.

The prolific increase in use of IoT appliances in computing systems, particularly within the cloud computing environment, in a variety of settings provide various beneficial uses to a user. For example, digital assistance usage has dramatically increased over the past few years. Moreover, usage of always-on listening devices (e.g., voice-activated devices) has also increased in homes, buildings, and other types of structures or environments. In aspect, a digital assistant (e.g., a voice activated hub) may one solve tasks with natural language inputs, in the form of spoken speech or written texts and may also answer questions about other modes like images. However, a current challenge of digital assistants where is the inability to incorporate information available in visual input.

Accordingly, the present invention provides for a cognitive system that implements intelligent problem solving using visual input to accomplish a task via an IoT device (e.g., a voice activated hub or “digital assistant”). An interactive dialog may be initiated using the one or more IoT computing devices for receiving one or more instructions, objectives, and the contextual information to define a selected task. Visual data and contextual information associated with the visual data may be collected from one or more IoT computing devices. One or more solutions may be provided for a selected task using the visual data and contextual data.

The cognitive system may perform a visual recognition, operation, natural language processing (“NLP”) operation to interpret the query. The cognitive system may personalize the context of the current user for providing the task solving strategies. The cognitive system may provide a task model of common tasks for the user and other related/similar users. A dynamic service composition operation may be performed to generate solutions to solve a task. In one aspect, a service composition may be an aggregate of services collectively composed to automate a particular task or process. The cognitive system may provide one or more useful solutions/answers to the question of the user, a suggestion for an action for performing the task, and/or a request for additional clarification from the user. For example, consider the following examples of use of the cognitive system.

### EXAMPLE 1

### Replacing a Computer Hard-Drive

1. The cognitive system may receive as input image from an ego-centric camera. 2. The cognitive system may receive a query from the user (e.g., a user provides a query such as, for example, “I want to replace the hard-disk”). 3. The cognitive system may use an image and query as input to classify a) a current state (e.g., a laptop placed on a desk with the user sitting at a desk as recognized from the image), and/or b) a goal of the user is provided in the query (goals may be “laptop battery replaced.” 4. The cognitive system may use a service composition based on a database of known services to determine: if a solution to the problem is known and/or any missing steps/inputs if the solution is unknown (e.g., need a serial number, need a screwdriver, etc.). 5. Also, the cognitive system may query the user for missing information such as, for example, “please turn over the laptop so I can see the serial number.” The cognitive system may then receive answer and go back to repeat step 4. If a solution to the problem is known, the cognitive system may output one or more instructions to the user.

### Example 2

### Navigation for Visually Challenged/Impaired Users

1. The cognitive system may identify and/or locate the user (e.g., user is located in a meeting room in and office building). 2. The cognitive system may receive a query from the user (e.g., a user provides a query such as, for example, “I want to buy groceries”). 3. The cognitive system may use visual input to determine the starting state is a location “X” (e.g., indoors). The cognitive system may use the query to determine the end point is location “Y” (e.g., grocery store). 4. From a database of known (atomic) solutions, the cognitive system may determine that navigating from an outdoor location to the grocery store is solved. 5. The cognitive system may query the user for additional information such as, for example, “do you know how to exit the building?” 6. The cognitive system may receive an answer to the query from the user such a, for example, “yes.” 7. The cognitive system may determine a complete solution is available from a variety of data sources and starts giving instructions. That is, the complete solution may be extracted from a task completion model, which may be a rule-based system (in which case a database lookup operation may be performed and/or sufficient) or the complete solution may be a machine learning based system in which even if the exact state is not found, feature space proximity may be used to generate instructions.

An additional example, using the various operations as described herein, may be used to enable domain experts to retrieve useful information depending on context (e.g., a doctor with patient quickly retrieves relevant documents).

The term “usefulness” or “useful” as used herein may refer to one or more actions having a positive impact upon assembling, repairing, and/or performing one or more actions, and/or efforts in relation to a selected task. Useful may be generally defined as the ability to be used for a practical purpose, capable of being put to use, serviceable for an end or purpose, and/or having value or productivity. It should be noted that one or more calculations may be performed using various mathematical operations or functions that may involve one or more mathematical operations (e.g., solving differential equations or partial differential equations analytically or computationally, using addition, subtraction, division, multiplication, standard deviations, means, averages, percentages, statistical modeling using statistical distributions, by finding minimums, maximums or similar thresholds for combined variables, etc.).

Other examples of various aspects of the illustrated embodiments, and corresponding benefits, will be described further herein.

It is understood in advance that although this disclosure includes a detailed description on cloud computing, implementation of the teachings recited herein are not limited to a cloud computing environment and/or computing systems associated with one or more medium/means. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

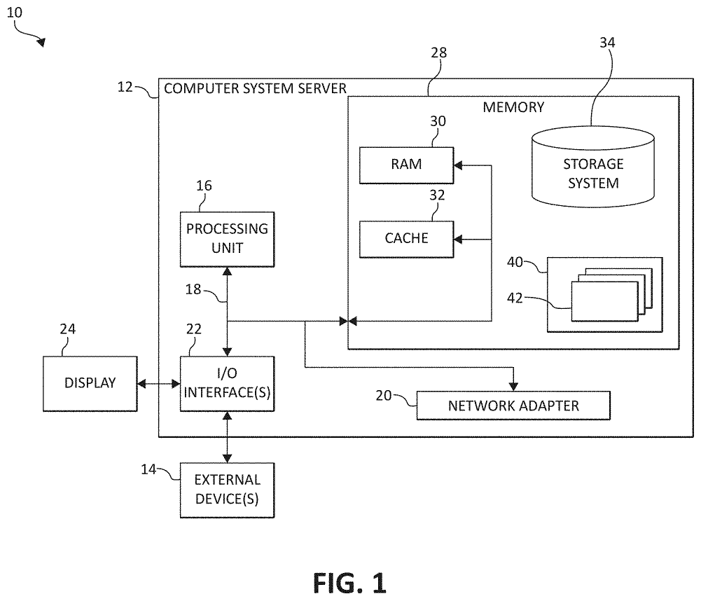

Referring now to FIG. 1, a schematic of an example of a computing node is shown. Computing node 10 (may be a cloud computing node) is only one example of a suitable computing node and is not intended to suggest any limitation as to the scope of use or functionality of embodiments of the invention described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

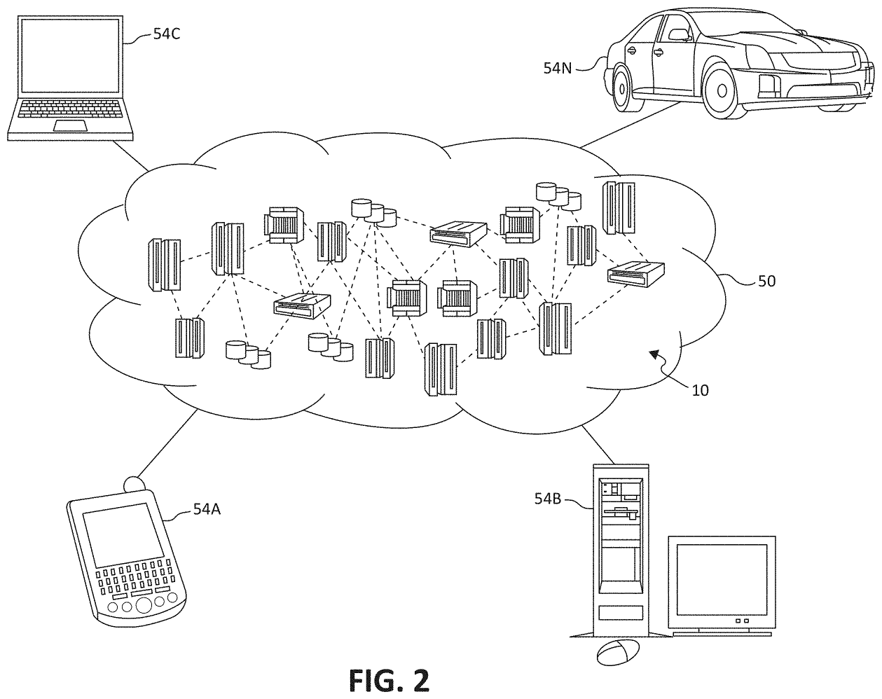

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

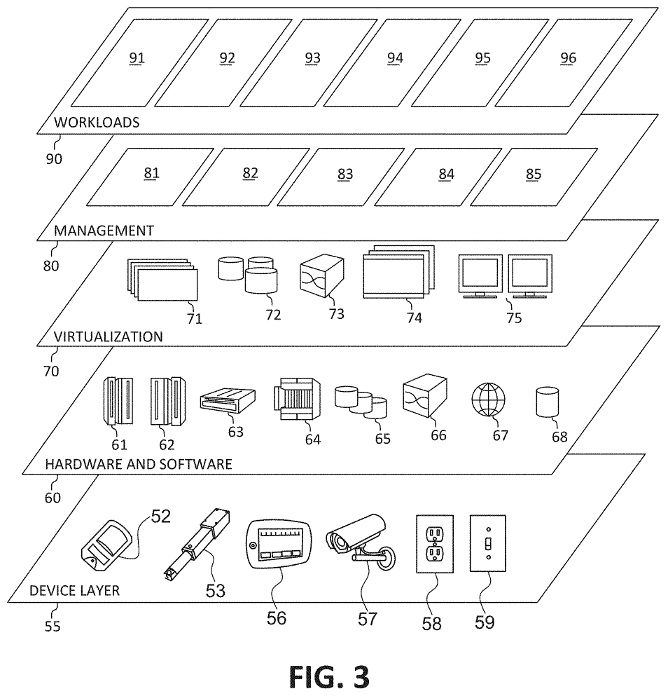

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for intelligent problem solving using visual input to accomplish a task. In addition, workloads and functions 96 for intelligent problem solving using visual input to accomplish a task may include such operations as data analytics, data analysis, and as will be further described, notification functionality. One of ordinary skill in the art will appreciate that the workloads and functions 96 for intelligent recommendation of guidance instructions may also work in conjunction with other portions of the various abstraction layers, such as those in hardware and software 60, virtualization 70, management 80, and other workloads 90 (such as data analytics processing 94, for example) to accomplish the various purposes of the illustrated embodiments of the present invention.

As stated above, the present invention provides a novel solution for intelligent problem solving using visual input to accomplish a task. An interactive dialog may be initiated using the one or more IoT computing devices for receiving one or more instructions, objectives, and the contextual information to define a selected task. Visual data and contextual information associated with the visual data may be collected from one or more Internet of Things (“IoT”) computing devices. One or more solutions may be for a selected task using the visual data and contextual data. For example, the cognitive system fetches instructional steps or videos from the cloud database or corpus. To locate a user, the intelligent problem solving service may perform real-time detection on an IoT device (e.g., personal digital assistant (PDA) or cellular telephone 54A, desktop computer 54B, laptop computer 54C, and/or automobile computer system 54N of FIG. 2).

The cognitive system may activate upon detection of a query from user as input. An Automated Speech Recognition (ASR) operation may be applied to convert the query to text. An image (e.g., camera fitted to user) may be captured to enhance or provide additional implicit input. The additional implicit contextual inputs of the user may be collected (e.g., time-of-day, location, social media data of similar users etc. Also, additional implicit history of user-cognitive system interaction may be collected. A query may be classified into one of the task classes using supervised machine learning approach (e.g., support vector machine “SVM”). The cognitive system may use the ASR text, the camera image and the additional contextual information. Depending on the task type and contextual information, one or more text suggestions may be generated (e.g., solutions provided in short sentences using the classification model). A speech-synthesis may be applied to the spoken suggestions to the user. The (suggestion, user action) tuple may be saved in a database as historical data.

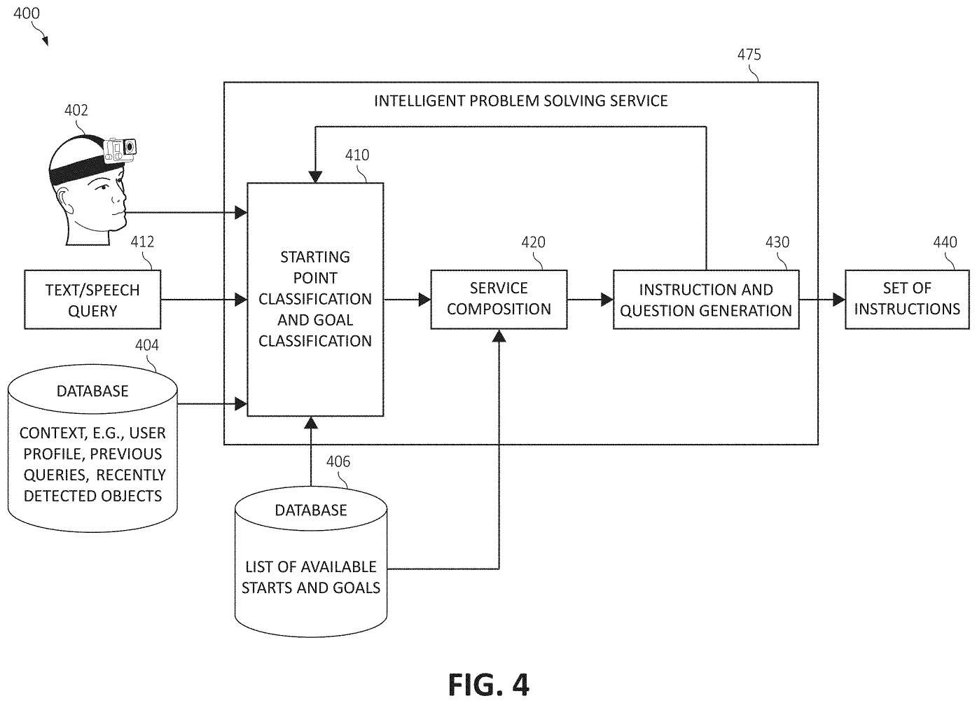

Turning now to FIG. 4, a block diagram of exemplary functionality 400 for intelligent problem solving using visual input according to various aspects of the present invention. As shown, the various blocks of functionality are depicted with arrows designating the blocks' 400 relationships with each other and to show process flow. Additionally, descriptive information is also seen relating each of the functional blocks 400. As will be seen, many of the functional blocks may also be considered “modules” of functionality, in the same descriptive sense as has been previously described in FIGS. 1-3. With the foregoing in mind, the module blocks 400 may also be incorporated into various hardware and software components of FIGS. 1-3. Many of the functional blocks 400 may execute as background processes on various components, either in distributed computing components, or on the user device, or elsewhere, and generally unaware to the user.

As a preliminary matter, the computer system/server 12 of FIG. 1 may provide an intelligent problem solving service 475 and may provide virtualized computing services (i.e., virtualized computing, virtualized storage, virtualized networking, etc.) to one or more computing devices, as described herein. More specifically, the computer system/server 12 may provide virtualized computing, virtualized storage, virtualized networking and other virtualized services that are executing on a hardware substrate.

The intelligent problem solving service 475 may be in communication with and/or association with one or more IoT computing devices 408 such as, for example a camera, television, smart phone, desktop computer, laptop computer, tablet, smart watch and/or another electronic/wireless communication device that may have one or more processors, memory, and/or other IoT computing devices 408 (e.g., personal digital assistant (PDA), cellular telephone 54A, desktop computer 54B, laptop computer 54C, and/or automobile computer system 54N of FIG. 2).

Starting in block 410, the intelligent problem solving service 475 may be activated by receiving a text/speech query 412 from a user 402, contextual data (e.g., a user profile, previous queries, recently detected objects, etc.) and a list of available starting information and goals from databases 404 and 406. The text/speech query 412 may include instructions, objectives, and the contextual information relating to a task to be identified and/or performed. The query may be classified in a task classification model. As part of block 410, the intelligent problem solving service 475 may perform a visual recognition, operation, natural language processing (“NLP”) operation to interpret the text/speech query 412. The intelligent problem solving service 475 may personalize the context of the current user using the contextual data and the list of available starting information and goals for providing the task solving strategies.

In block 420, a dynamic service composition operation may be performed to generate solutions to solve a task relating to the query. In one aspect, a service composition may be an aggregate of services collectively composed to automate a particular task or process.

In one aspect, a database (e.g., databases 404 and/or 406) may include one or more atomic tasks specified by input/output or start state/end-state such as, for example in the following format: (name: determine item to buy, input: item name, output: item is known), (name: take out wallet, input: none, output: payment method available), (name: make purchase, input: payment method, item name, output: item is purchased).

Based on the database (e.g., databases 404 and/or 406), if a task is specified such as, for example, “I want to purchase item X,” the intelligent problem solving service 475 may separate and/or break down the task into smaller sub-tasks. The original task may be solved by composing the solutions to each of the subtasks.

As in block 430, the intelligent problem solving service 475 may provide instruction and question generation. That is, the intelligent problem solving service 475 may provide one or more useful solutions/answers to the question of the user and/or a suggestion for an action for performing the task (e.g., as a set of instructions 440). In the event that information is missing or required, additional clarification from the user may also be obtained by returning to block 410 to submit one or more queries back to the user 402. When there are gaps/missing information in a chain of atomic tasks needed to solve the problem, the intelligent problem solving service 475 may queries the user 402. If the user 402 answers that they know how to perform a step in the complete solution, this known step by the user 402 may be added to the database 404/406 of atomic tasks. The databases 404/406 (e.g., databases of atomic tasks) may be shared between users.

In additional aspect, the database (e.g., databases 404 and/or 406) may include a domain knowledge (e.g., a database that may include an ontology) that may include and/or be associated with an ontology of concepts, keywords, expressions representing a domain of knowledge. A thesaurus or ontology may be used as the database and may also be used to identify semantic relationships between observed and/or unobserved variables by A machine learning operation performed by the intelligent problem solving service 475 (e.g., a cognitive system). In one aspect, the term “domain” is a term intended to have its ordinary meaning. In addition, the term “domain” may include an area of expertise for a system or a collection of material, information, content and/or other resources related to a particular subject or subjects. A domain can refer to information related to any particular subject matter or a combination of selected subjects.

The term ontology is also a term intended to have its ordinary meaning. In one aspect, the term ontology in its broadest sense may include anything that can be modeled as an ontology, including but not limited to, taxonomies, thesauri, vocabularies, and the like. For example, an ontology may include information or content relevant to a domain of interest or content of a particular class or concept. The ontology can be continuously updated with the information synchronized with the sources, adding information from the sources to the ontology as models, attributes of models, or associations between models within the ontology.

Additionally, the database (e.g., databases 404 and/or 406) may include one or more external resources such as, for example, links to one or more Internet domains, webpages, and the like. For example, text data may be hyperlinked to a webpage that may describe, explain, or provide additional information relating to the text data. Thus, a summary may be enhanced via links to external resources that further explain, instruct, illustrate, provide context, and/or additional information to support a decision, alternative suggestion, alternative choice, and/or criteria.

In one aspect, the intelligent problem solving service 475, as described herein, may be performed by a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

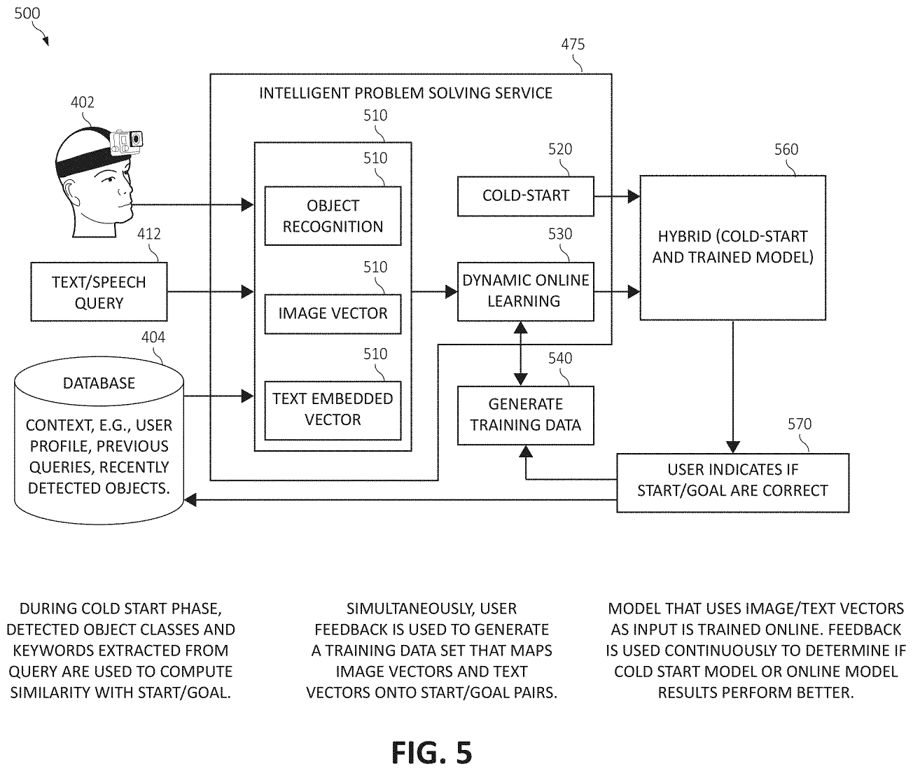

Turning now to FIG. 5, a block diagram of exemplary functionality 500 for initiating goal classification using the intelligent problem solving service 475 of FIG. 4 according to various aspects of the present invention. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIGS. 1-4 (e.g., user 402, database 404, text/speech query 412, etc.). With the foregoing in mind, the module blocks 500 may also be incorporated into various hardware and software components of FIGS. 1-4. Many of the functional blocks 500 may execute as background processes on various components, either in distributed computing components, or on the user device, or elsewhere, and generally unaware to the user.

Starting with block 510, the intelligent problem solving service 475 of FIG. 4 may be activated by receiving a text/speech query 412 from a user 402 contextual data (e.g., a user profile, previous queries, recently detected objects) from databases 404.

Hence, in block 510, video data and/or the text/speech query 412 from 502 may be received and used to define one or more objects via an object recognition operation 512, image vector 514 and/or text embedded vector 516. Using the data from block 510, the intelligent problem solving service 475 performs a cold start operation, as in block 520. In the cold start phase, the intelligent problem solving service 475 begins the cold start operation to detect object classes from image data and/or identify and extract keywords from the text/speech query 412 to determine a starting point and goal (e.g., compute similarity with start/goal) since a list of available starting information and goals is unavailable. The similarity may involve text overlap or similarity between embedded representations of start/goal states and the current task state of the current task.

The cold-start component involves an outlier detection component which checks to see if the current task at hand is an outlier (i.e., the system has previously encountered tasks similar to current task, which is new and “outlier”). The system may then follow a “default” or a “fallback” strategy, as in block 520. In principle, the cold-start and the task-trained model may be combined, as in block 560. Simultaneously with block 520, dynamic online learning may be performed, as in block 530. That is, a training model uses image/text vectors 514 and/or 516 as input from user 402 is trained online. A hybrid operation (e.g., a cold-start and trained model) may be performed, as in block 560.

From block 560, the user 402 may provide feedback to indicate if the determined start information/goal are correct, as in block 570. The feedback may be continuously used to determine if a cold start training model or online model results perform better. Simultaneously, user feedback may be used to generate a training data set that maps image vectors and text vectors onto start/goal pairs (e.g., a cold start training model), as in block 540. The cold start training model generated in block 540 may be used/supplied for the dynamic online learning of block 530.

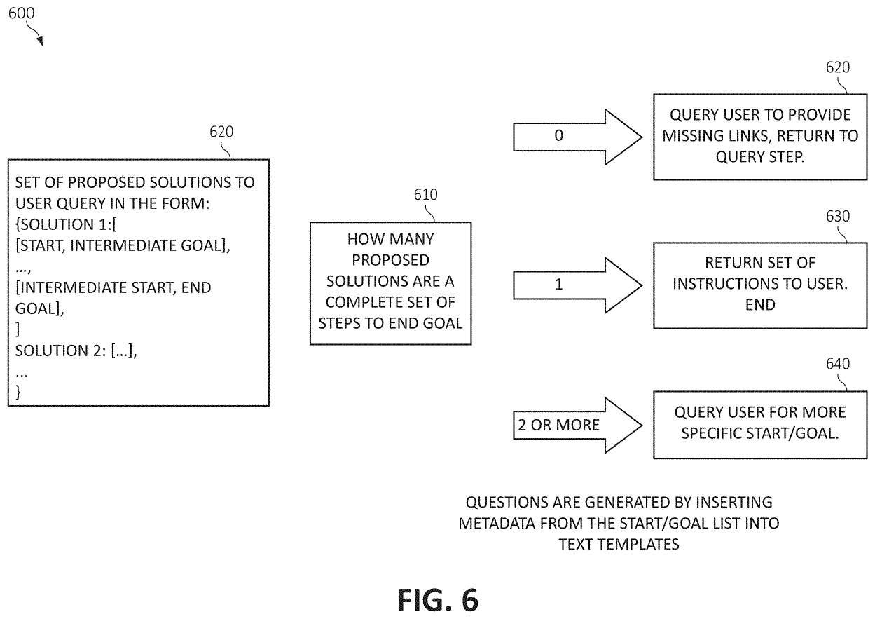

Turning now to FIG. 6, a block diagram of exemplary functionality 600 for instruction/query generation using an intelligent problem solving service according to various aspects of the present invention. As shown, the various blocks of functionality are depicted with arrows designating the blocks' 600 relationships with each other and to show process flow. Additionally, descriptive information is also seen relating each of the functional blocks 500. As will be seen, many of the functional blocks may also be considered “modules” of functionality, in the same descriptive sense as has been previously described in FIGS. 1-5. With the foregoing in mind, the module blocks 500 may also be incorporated into various hardware and software components of FIGS. 1-5. Repetitive description of like elements employed in other embodiments described herein is omitted for sake of brevity.

Starting in block 602, a set of proposed solution may be provided to the user in one or more forms such as, solution 1 illustrated with pseudocode. In one aspect, the queries/questions may be generated by inserting metadata from the start/goal list into text templates.

In block 610, a determination operation is performed to identify a number of proposed solutions that are a complete set of steps beginning from a starting point to an end point of an end goal (e.g., how many proposed solutions are a complete set of steps to the end goal). If there are zero (“0”) complete sets of solutions, a user may be queried to providing missing links (e.g., missing information, steps, sub-tasks), as in block 620. If is are one “1” complete set of solutions, the set of solutions/instructions may be returned to the user (and the process may be complete/end3, as in block 630. If there are two or more complete sets of solutions, a user may be queried to provide more specific information relating to a starting point/goal, as in block 640.

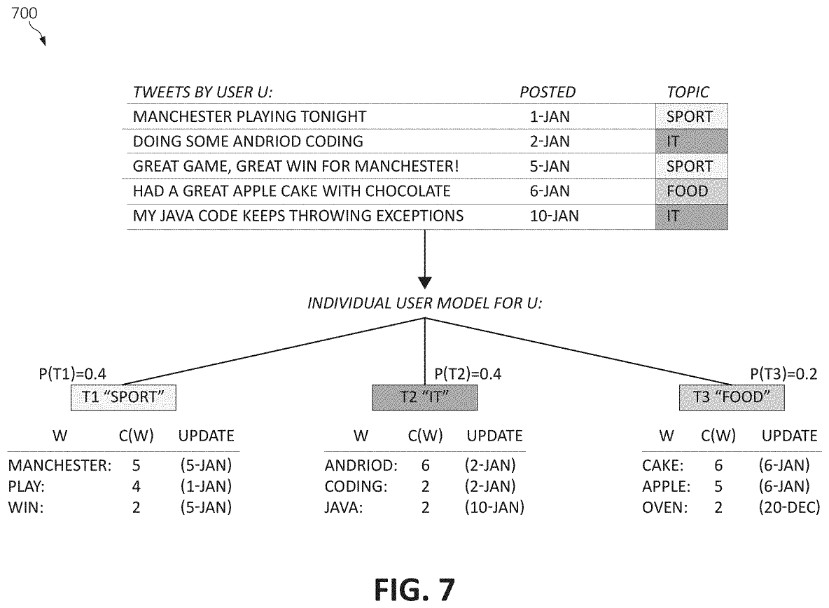

FIG. 7 is diagram depicting a user model 700 for implementing an intelligent problem solving service. As shown, the various blocks of functionality are depicted with arrows designating the blocks' 700 relationships with each other and to show process flow. Additionally, descriptive information is also seen relating each of the functional blocks 700. As will be seen, many of the functional blocks may also be considered “modules” of functionality, in the same descriptive sense as has been previously described in FIGS. 1-6. With the foregoing in mind, the module blocks 700 may also be incorporated into various hardware and software components of FIGS. 1-6. Repetitive description of like elements employed in other embodiments described herein is omitted for sake of brevity.

As depicted, a collection of a series of social media communications/posts 710 may be analyzed and modeled such as, for example, by date posted and topic (e.g., sports, food, technology (“IT”). That is, the user model 700 illustrates one or more short-term (e.g., less than a defined time period) interests of users (in various topics) with user models (e.g., T1, T2, and T3) created based on topic from social media posts and search (engine) history. For example, user model 700 illustrates that a user is interested topics such as, for example, sports, technology (“IT”) and food. Thus, it is likely that the user would like to use the intelligent problem solving service to accomplish tasks related to either of these three domains. In one aspect, one or more machine learning operations may be employed for topic modeling and/or word vector embedding to model topics, which may be word-topic association likelihood.

One or more long term interests (e.g., less than a defined time period) may be constructed by extracting informative words from one or more social media and/or online corporate user profiles. It should be noted that one or more machine learning models could be linearly combined.

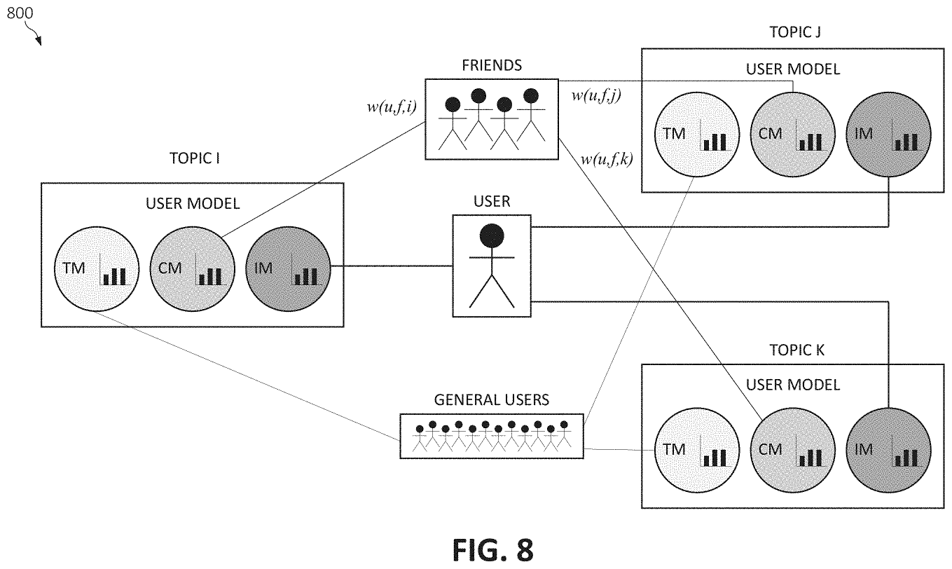

FIG. 8 is diagram depicting a similar user model 800 for modeling of similar users. As illustrated, the similar user model 800 may be a user model that is a linear combination of IM (individual), CM (cohort), and TM (global) cohorts/similar users to address the cold-start operation, described herein, of a current user by learning/imbibing information from other similar users.

In one aspect, the similar user model 800 may be constructed/built of user ‘cohorts’ from one or more social media connections, which may consider multiple topics (e.g., topic I, topic J, and/or topic K). The similar user model 800 may include the IM (individual) model, CM (cohort) model, and/or the TM (global) model each of which may be fed into a classification operation (e.g., a classifier system) along with a visual image and/a query pair as additional context. That is, a current user query may topically deviate from the user model (i.e., the things which the user typical does). This may happen if the user wants to accomplish a task that is not a part of the user's daily routine (e.g., the user is on a vacation). In that case, the current query (e.g., in text form) and the images (e.g., from the camera) may provide the additional context to classify the current query. Additional information from other users may be obtained and used for a current to further learn and identify similar solutions, similar results, and alternative feedback from users having similar contextual data/environments.

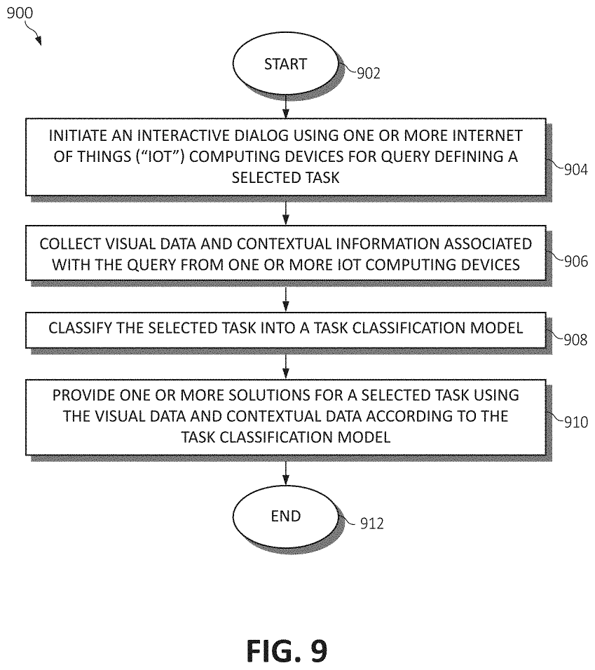

FIG. 9 is an additional flowchart diagram depicting an additional exemplary method 900 for intelligent problem solving using visual input by a processor, again in which aspects of the present invention may be realized. The functionality 900 may be implemented as a method executed as instructions on a machine, where the instructions are included on at least one computer readable medium or one non-transitory machine-readable storage medium. The functionality 900 may start in block 902.

An interactive dialog using one or more IoT computing devices for query defining a selected task, as in block 904. Visual data and contextual information, associated with the query, may be collected from one or more IoT computing devices, as in block 906. The selected task identified from the query (e.g., using the visual data and/or contextual information) may be classified into a task classification model, as in block 908. One or more solutions may be provided for a selected task using the visual data and contextual data according to the task classification model, as in block 910. The functionality 900 may end, as in block 912.

In one aspect, in conjunction with and/or as part of at least one block of FIG. 9, the operations of method 900 may include each of the following. The operations of method 900 may augment the interactive dialog using the one or more IoT computing devices with the visual data. Natural language processing (NLP), automated speech recognition (ASR), lexical analysis, semantic analysis, visual recognition analysis, or a combination thereof may be used to learn or identify one or more instructions, task objectives, and the contextual information defining the selected task.

The operations of method 900 may also provide a user with one or more sub-tasks solutions to perform the selected task according to a task classification model and/or provide one or more similar solutions of one or more alternative users for completing the selected task. The operations of method 900 may access a knowledge domain according to a task classification model for providing one or more solutions for a selected task. The one or more solutions for the selected task may also be enhanced via an interactive dialog with a user upon determining additional information is required from performing the selected task.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method for intelligent problem solving using visual input by a processor, comprising:
collecting visual data and contextual information associated with the visual data from one or more Internet of Things (“IoT”) computing devices; and
providing one or more solutions for a selected task using the visual data and contextual data.

2. The method of claim 1, further includes initiating an interactive dialog using the one or more IoT computing devices for receiving one or more instructions, objectives, and the contextual information defining the selected task.

3. The method of claim 2, further includes augmenting the interactive dialog using the one or more IoT computing devices with the visual data.

4. The method of claim 1, further including using natural language processing (NLP), automated speech recognition (ASR), lexical analysis, semantic analysis, visual recognition analysis, or a combination thereof to learn or identify one or more instructions, task objectives, and the contextual information defining the selected task.

5. The method of claim 1, further including:
classifying the selected task into a task classification model; and
providing a user with one or more sub-tasks solutions to perform the selected task according to the task classification model.

6. The method of claim 1, further including providing one or more similar solutions of one or more alternative users for completing the selected task.

7. The method of claim 1, further including:
accessing a knowledge domain according to a task classification model for providing one or more solutions for the selected task; and
enhancing the one or more solutions for the selected task via an interactive dialog with a user upon determining additional information is required from performing the selected task.

8. A system for intelligent problem solving using visual input, comprising:
one or more computers with executable instructions that when executed cause the system to:
collect visual data and contextual information associated with the visual data from one or more Internet of Things (“IoT”) computing devices; and
provide one or more solutions for a selected task using the visual data and contextual data.

9. The system of claim 8, wherein the executable instructions further initiate an interactive dialog using the one or more IoT computing devices for receiving one or more instructions, objectives, and the contextual information defining the selected task.

10. The system of claim 9, wherein the executable instructions further augment the interactive dialog using the one or more IoT computing devices with the visual data.

11. The system of claim 8, wherein the executable instructions further use natural language processing (NLP), automated speech recognition (ASR), lexical analysis, semantic analysis, visual recognition analysis, or a combination thereof to learn or identify one or more instructions, task objectives, and the contextual information defining the selected task.

12. The system of claim 8, wherein the executable instructions further:
classify the selected task into a task classification model; and
provide a user with one or more sub-tasks solutions to perform the selected task according to the task classification model.

13. The system of claim 8, wherein the executable instructions further provide one or more similar solutions of one or more alternative users for completing the selected task.

14. The system of claim 8, wherein the executable instructions further:
access a knowledge domain according to a task classification model for providing one or more solutions for the selected task; and
enhance the one or more solutions for the selected task via an interactive dialog with a user upon determining additional information is required from performing the selected task.

15. A computer program product for intelligent problem solving using visual input by a processor, the computer program product comprising a non-transitory computer-readable storage medium having computer-readable program code portions stored therein, the computer-readable program code portions comprising:
an executable portion that collects visual data and contextual information associated with the visual data from one or more Internet of Things (“IoT”) computing devices; and
an executable portion that provides one or more solutions for a selected task using the visual data and contextual data.

16. The computer program product of claim 15, further including an executable portion that:
initiates an interactive dialog using the one or more IoT computing devices for receiving one or more instructions, objectives, and the contextual information defining the selected task; and
augments the interactive dialog using the one or more IoT computing devices with the visual data.

17. The computer program product of claim 15, further including an executable portion that uses natural language processing (NLP), automated speech recognition (ASR), lexical analysis, semantic analysis, visual recognition analysis, or a combination thereof to learn or identify one or more instructions, task objectives, and the contextual information defining the selected task.

18. The computer program product of claim 15, further including an executable portion that:
classifies the selected task into a task classification model; and
provides a user with one or more sub-tasks solutions to perform the selected task according to the task classification model.

19. The computer program product of claim 15, further including an executable portion that provides one or more similar solutions of one or more alternative users for completing the selected task.

20. The computer program product of claim 15, further including an executable portion that:
accesses a knowledge domain according to a task classification model for providing one or more solutions for the selected task; and
enhances the one or more solutions for the selected task via an interactive dialog with a user upon determining additional information is required from performing the selected task.
